(19) United States
(12) Patent Application Publication
(10) Pub. No.: US 2024/0386168 A1
(43) Pub. Date: Nov. 21, 2024

(54) COMPUTER-READABLE RECORDING MEDIUM STORING SIMULATION PROGRAM, SIMULATION APPARATUS, AND SIMULATION METHOD

(71) Applicant: Fujitsu Limited, Kawasaki-shi (JP)

(72) Inventor: Amir HADERBACHE, Kawasaki (JP)

(73) Assignee: Fujitsu Limited, Kawasaki-shi (JP)

(21) Appl. No.: 18/636,954

(22) Filed: Apr. 16, 2024

(30) Foreign Application Priority Data
May 18, 2023 (JP) 2023-082154

(51) Int. Cl. G06F 30/27; G06F 30/23; G06F 119/02

(52) U.S. Cl. CPC G06F 30/27; G06F 30/23; G06F 2119/02

(57) ABSTRACT

A recording medium stores a simulation program for causing a computer to execute a process. The process includes: iterating first analysis processing based on a first generation method for generating a stiffness matrix of an analysis target; calculating an index related to an error of the stiffness matrix after the first analysis processing is iterated; changing the first generation method to a second generation method having higher accuracy based on the index related to the error; and iterating second analysis processing based on the second generation method, wherein the first analysis processing includes generating the stiffness matrix by the first generation method, and calculating a physical quantity related to the target, and the second analysis processing includes generating the stiffness matrix by the second generation method, and calculating the physical quantity related to the target.

### CROSS-REFERENCE TO RELATED APPLICATION

This application is based upon and claims the benefit of priority of the prior Japanese Patent Application No. 2023-82154, filed on May 18, 2023, the entire contents of which are incorporated herein by reference.

### FIELD

The embodiment discussed herein is related to a simulation technique.

### BACKGROUND

A structure analysis simulation is a simulation for calculating a temporal change and a spatial change of a physical quantity related to an object to which an external force is applied. A simulation program for the structure analysis simulation calculates physical quantities such as displacement and stress by solving a partial differential equation by, for example, a finite element method (FEM).

A calculation window processing technique for mechanical analysis, thermomechanical analysis, electromechanical analysis, and/or magnetomechanical analysis of finite elements is known for the FEM. A method for performing a numerical simulation of a physical behavior of a physical region by a computer by using computer-aided engineering (CAE) analysis is also known.

U.S. Patent Application Publication No. 2020/0226310, Japanese National Publication of International Patent Application No. 2022-517229, U.S. Patent Application Publication No. 2014/0343899, and Japanese Laid-open Patent Publication No. 2014-225257 are disclosed as related art.

### SUMMARY

According to an aspect of the embodiments, a transitory computer-readable recording medium storing a simulation program for causing a computer to execute a process includes: iterating first analysis processing based on a first generation method for generating a stiffness matrix of an analysis target; calculating an index related to an error of the stiffness matrix generated by the first generation method after the first analysis processing is iterated; changing the first generation method to a second generation method that has higher accuracy than the first generation method based on the index related to the error; and iterating second analysis processing based on the second generation method, wherein the first analysis processing includes generating the stiffness matrix of the analysis target by the first generation method, and calculating a physical quantity related to the analysis target by using the stiffness matrix generated by the first generation method, and the second analysis processing includes generating the stiffness matrix of the analysis target by the second generation method, and calculating the physical quantity related to the analysis target by using the stiffness matrix generated by the second generation method.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a temporal change in stress in a structure analysis simulation;

FIG. 2 is a functional configuration diagram of a simulation apparatus according to an embodiment;

FIG. 3 is a flowchart of first simulation processing;

FIG. 4 is a functional configuration diagram of a specific example of the simulation apparatus;

FIG. 5 is a diagram illustrating a temporal change in stress in a structure analysis simulation of the embodiment;

FIG. 6 is a diagram illustrating a first temporal change in an L1 norm;

FIG. 7 is a diagram illustrating a temporal change in an L2 norm;

FIG. 8 is a diagram illustrating a temporal change in a maximum value norm;

FIG. 9 is a diagram illustrating a second temporal change in the L1 norm;

FIG. 10A is a flowchart (part 1) of second simulation processing;

FIG. 10B is a flowchart (part 2) of the second simulation processing;

FIG. 10C is a flowchart (part 3) of the second simulation processing; and

FIG. 11 is a hardware configuration diagram of an information processing apparatus.

### DESCRIPTION OF EMBODIMENTS

In the structure analysis simulation of the object, in a case where a stiffness matrix is generated by using a neural network trained by machine learning instead of a numerical calculation method based on the FEM, analysis accuracy deteriorates as a time step progresses. Hereinafter, the numerical calculation method based on the FEM may be simply referred to as the FEM.

Such a problem occurs not only in a case where the stiffness matrix is generated by the neural network instead of the FEM but also in a case where the stiffness matrix is generated by various generation methods having lower accuracy than the FEM.

According to one aspect, an object of the present disclosure is to improve calculation accuracy of a simulation for calculating a physical quantity while generating a stiffness matrix of an analysis target.

Hereinafter, an embodiment will be described in detail with reference to the drawings.

An analysis method in which a nonlinear algorithm such as a Newton-Raphson method and a time advancement method are combined may be used in a nonlinear dynamic analysis in a structure analysis simulation of an object.

According to such an analysis method, one or a plurality of approximate calculation steps are iterated for each time step. In each approximate calculation step, an approximate solution of a physical quantity is calculated by generating a new stiffness matrix and solving a system of linear equations using the generated stiffness matrix as a coefficient matrix. The approximate calculation step may be referred to as iteration.

In nonlinear dynamic analysis using a supercomputer, in a case where the stiffness matrix is generated by a numerical calculation method based on an FEM in each approximate calculation step, a time during which the stiffness matrix is calculated is much longer than a time during which a solution of the system of linear equations is calculated in many cases. Thus, a time taken to generate the stiffness matrix occupies most of an execution time of the structure analysis simulation.

On the other hand, in the case where the stiffness matrix is generated by a neural network trained by machine learning, the time taken to generate the stiffness matrix is shorter than that in the case of the FEM. For example, in an example of a structure analysis simulation of Earth's crust when an earthquake occurs, a calculation time of the stiffness matrix by the neural network is about ⅓ of a calculation time of the stiffness matrix by the FEM.

However, it is difficult to train the neural network such that highly accurate analysis results are obtained over all time steps of the structure analysis simulation. Thus, when the generation of the stiffness matrix by the neural network is iterated over a certain number of times of time steps, large errors are accumulated. Since the accumulated error in the stiffness matrix has a serious influence on convergence of a nonlinear algorithm for calculating a physical quantity, accuracy of the calculated physical quantity deteriorates.

For example, although the neural network may generate the stiffness matrix at a higher speed than the FEM, accuracy of the stiffness matrix generated by the neural network is lower than accuracy of the stiffness matrix generated by the FEM. Accordingly, analysis accuracy of the structure analysis simulation using the neural network is lower than analysis accuracy of the structure analysis simulation using the FEM.

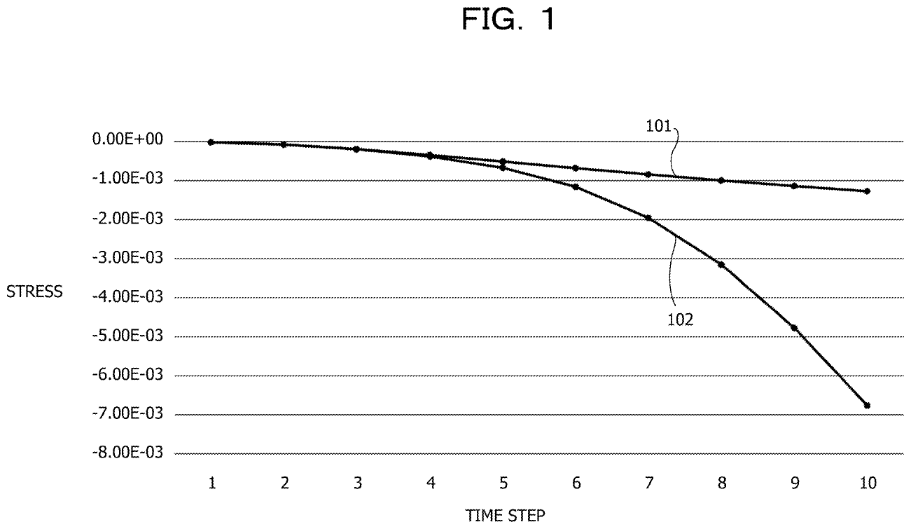

FIG. 1 illustrates an example of a temporal change in stress in a structure analysis simulation of the Earth's crust when an earthquake occurs. In this example, the Earth's crust in a specific region is divided into a plurality of elements in the FEM. Each element is represented by a hexahedron having eight nodes.

A horizontal axis represents a time step, and a vertical axis represents stress in a predetermined direction at a specific node of a specific element. E on the vertical axis represents a power of 10. A polygonal line 101 indicates a temporal change in stress in a case where the stiffness matrix is generated by the FEM. A polygonal line 102 indicates a temporal change in stress in a case where the stiffness matrix is generated by the neural network.

Comparison of the polygonal line 101 and the polygonal line 102 indicates that, as the time step progresses, calculation accuracy of the stress in a case where the neural network is used deteriorates, and a difference in stress gradually increases. For example, the difference in stress between the polygonal line 101 and the polygonal line 102 in time step 5 is 0.00015, and the difference in stress between the polygonal line 101 and the polygonal line 102 in time step 10 is 0.0055.

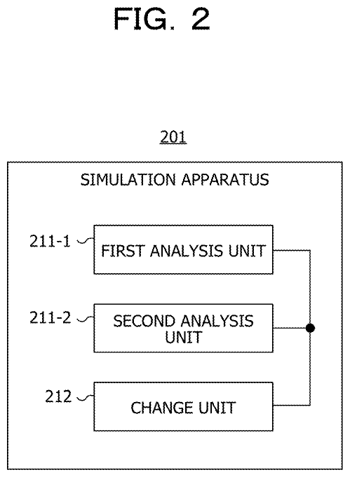

FIG. 2 illustrates a functional configuration example of a simulation apparatus of an embodiment. A simulation apparatus 201 in FIG. 2 includes a first analysis unit 211-1, a second analysis unit 211-2, and a change unit 212.

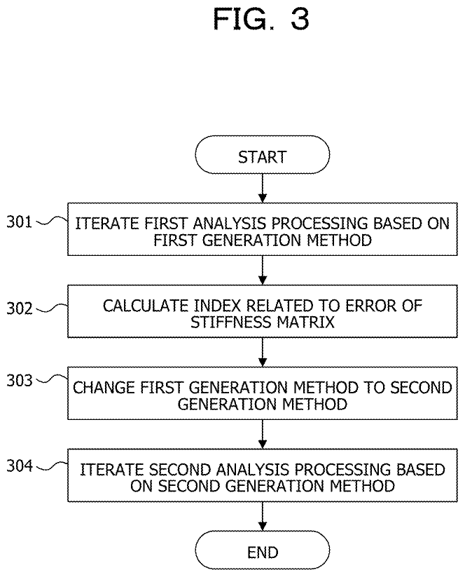

FIG. 3 is a flowchart illustrating an example of first simulation processing performed by the simulation apparatus 201 in FIG. 2. First, the first analysis unit 211-1 iterates first analysis processing based on a first generation method for generating a stiffness matrix of an analysis target (step 301). The first analysis processing includes processing of generating the stiffness matrix of the analysis target by the first generation method and processing of calculating a physical quantity related to the analysis target by using the stiffness matrix generated by the first generation method.

Subsequently, after the first analysis processing is iterated, the change unit 212 calculates an index related to the error of the stiffness matrix generated by the first generation method (step 302). Based on the index related to the error, the change unit 212 changes the first generation method to a second generation method that has higher accuracy than the first generation method (step 303).

Subsequently, the second analysis unit 211-2 iterates second analysis processing based on the second generation method (step 304). The second analysis processing includes processing of generating the stiffness matrix of the analysis target by the second generation method and processing of calculating the physical quantity related to the analysis target by using the stiffness matrix generated by the second generation method.

According to the simulation apparatus 201 in FIG. 2, the calculation accuracy of the simulation for calculating the physical quantity while generating the stiffness matrix of the analysis target may be improved.

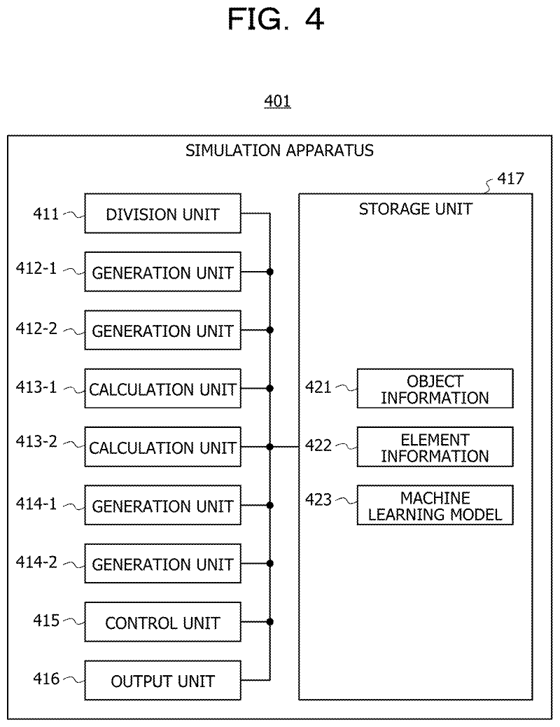

FIG. 4 illustrates a specific example of the simulation apparatus 201 in FIG. 2. A simulation apparatus 401 in FIG. 4 includes a division unit 411, a generation unit 412-1, a generation unit 412-2, a calculation unit 413-1, a calculation unit 413-2, a generation unit 414-1, a generation unit 414-2, a control unit 415, an output unit 416, and a storage unit 417.

The generation unit 412-1 and the calculation unit 413-1 correspond to the first analysis unit 211-1 in FIG. 2, and the generation unit 412-2 and the calculation unit 413-2 correspond to the second analysis unit 211-2 in FIG. 2. The generation unit 414-1, the generation unit 414-2, and the control unit 415 correspond to the change unit 212 in FIG. 2.

The simulation apparatus 401 performs a structure analysis simulation of an object in CAE, structure design, engineering design, or the like. An object as a target of the structure analysis simulation may be a structure such as a road, a bridge, or a building, may be the Earth's crust, a fluid, or the like, or may be an industrial product.

In the structure analysis simulation, one or a plurality of approximate calculation steps are iterated for each time step. In each approximate calculation step, a physical quantity such as displacement or stress is calculated by generating a new stiffness matrix and solving a system of linear equations using the generated stiffness matrix as a coefficient matrix. The displacement or stress corresponds to a physical quantity related to an object.

The storage unit 417 stores object information 421 representing a shape of an object. The division unit 411 divides an object represented by the object information 421 into a plurality of elements, generates element information 422 representing each of the plurality of elements, and stores the element information in the storage unit 417. Each element has a plurality of nodes, and the element information 422 of each element includes identification information and positional information of each node of the element. A shape of each element may be a polyhedron. The plurality of elements generated by the division unit 411 is an example of a plurality of elements that represent the analysis target.

In each approximate calculation step of each time step, the generation unit 412-1 generates an element stiffness matrix of each element by the first generation method by using the element information 422 of the element. For the generation of the element stiffness matrix, the physical quantity of each node calculated in an immediately preceding time step or the physical quantity of each node calculated in an immediately preceding approximate calculation step of the same time step is used.

For example, a generation method for generating an element stiffness matrix having lower accuracy than the FEM at a higher speed than the FEM is used as the first generation method. The first generation method is, for example, a generation method for generating an element stiffness matrix by using a trained machine learning model 423 stored in the storage unit 417. A neural network, a random forest, or the like is used as the machine learning model 423.

The machine learning model 423 infers an element stiffness matrix of an element by using a physical quantity of each of the plurality of nodes of the element as an input, and outputs the inferred element stiffness matrix. The machine learning model 423 may simultaneously infer element stiffness matrices of two or more elements. The machine learning model 423 is used, and thus, the element stiffness matrix may be generated at a high speed.

The machine learning model 423 is generated by training a machine learning model before training, by supervised machine learning. For example, the physical quantity of each node of each of the plurality of elements in an initial time step of the structure analysis simulation may be used as training data to be input. The element stiffness matrix of each element used as a ground truth label is generated from the same training data by, for example, the second generation method to be described later.

In each approximate calculation step of each time step, the calculation unit 413-1 generates the stiffness matrix of the entire object by using the element stiffness matrix of each element generated by the first generation method. By using the stiffness matrix of the entire object, the calculation unit 413-1 calculates the physical quantity of each node of each element.

The output unit 416 outputs, as an analysis result in each time step, a physical quantity calculated in a last approximate calculation step of the time step.

Processing performed by the generation unit 412-1 and the calculation unit 413-1 corresponds to the first analysis processing based on the first generation method.

In each approximate calculation step of each time step, the generation unit 412-2 generates the element stiffness matrix of each element by the second generation method by using the element information 422 of the element. For the generation of the element stiffness matrix, the physical quantity of each node calculated in an immediately preceding time step or the physical quantity of each node calculated in an immediately preceding approximate calculation step of the same time step is used.

For example, a generation method for generating an element stiffness matrix having higher accuracy than in the first generation method over a longer time than in the first generation method is used as the second generation method. For example, the second generation method is the FEM. The FEM may be a numerical calculation method such as an F-bar method. The FEM is used, and thus, a more accurate element stiffness matrix may be generated.

In each approximate calculation step of each time step, the calculation unit 413-2 generates the stiffness matrix of the entire object by using the element stiffness matrix of each element generated by the second generation method. By using the stiffness matrix of the entire object, the calculation unit 413-2 calculates the physical quantity of each node of each element.

The output unit 416 outputs, as an analysis result in each time step, a physical quantity calculated in a last approximate calculation step of the time step.

Processing performed by the generation unit 412-2 and the calculation unit 413-2 corresponds to the second analysis processing based on the second generation method.

In a time step of error evaluation after the first analysis processing is iterated by the generation unit 412-1 and the calculation unit 413-1, the control unit 415 evaluates an error of a stiffness matrix generated next by the first generation method. The control unit 415 determines whether or not to change the first generation method to the second generation method based on the evaluation result. The time step of the error evaluation may be set at a ratio of once per a certain number of times of time steps.

In the time step of the error evaluation, the generation unit 414-1 uses, as an evaluation target element, any one or a plurality of elements among the plurality of elements represented by the element information 422. The generation unit 414-1 generates an element stiffness matrix M1 of each evaluation target element by the first generation method in the same manner as the generation unit 412-1. The element stiffness matrix M1 is an example of a first element stiffness matrix.

The generation unit 414-2 generates an element stiffness matrix M2 of each evaluation target element by the second generation method in the same manner as the generation unit 412-2. The element stiffness matrix M2 is an example of a second element stiffness matrix.

The control unit 415 calculates an index ER related to the error of the stiffness matrix by using the element stiffness matrix M1 and the element stiffness matrix M2 of each evaluation target element. For example, a statistical value of a mean absolute error (MAE) of the element stiffness matrix M1 and the element stiffness matrix M2 is used as the index ER. For example, the control unit 415 calculates E(M1, M2) representing the MAE of the element stiffness matrix M1 and the element stiffness matrix M2 by Equation below.

E(M1,M2)=(1/N2)*ΣᵢΣⱼ|M2(i,j)−M1(i,j)| (1)

N represents the number of rows and columns of the element stiffness matrix M1. The number of rows and columns of the element stiffness matrix M2 is N. Σᵢ represents a total sum for i=1 to N, and Σⱼ represents a total sum for j=1 to N. For example, in a case where each element has eight nodes and a degree of freedom of each node is 3, N=3*8=24.

M1(i, j) represents a matrix element at an i-th row and a j-th column of the element stiffness matrix M1, and M2 (i, j) represents a matrix element at an i-th row and a j-th column of the element stiffness matrix M2. |M2(i, j)−M1(i, j) |represents an absolute value of M2(i, j)−M1(i, j).

A mean value, a minimum value, a maximum value, or the like of E(M1, M2) of all the evaluation target elements is used as the statistical value of E(M1, M2). The number of evaluation target elements may be about one several hundredth to one several tenth of a total number of elements representing the object. A mean error, a root mean square error, or the like may be used instead of E(M1, M2) in Equation (1).

By comparing the index ER with a threshold TH1, the control unit 415 evaluates the error of the stiffness matrix to be generated next by the first generation method. The threshold TH1 may be designated by a user or may be calculated based on an experiment result.

For example, in a case where the index ER is larger than the threshold TH1, the control unit 415 determines that the error caused by the first generation method is accumulated, and changes the first generation method to the second generation method with higher accuracy than the first generation method. In this case, the first analysis processing by the generation unit 412-1 and the calculation unit 413-1 is ended, and the second analysis processing by the generation unit 412-2 and the calculation unit 413-2 is started.

The generation method of the stiffness matrix is switched to the second generation method in a case where the error of the stiffness matrix is accumulated by iterating the first analysis processing, and thus, the error of the stiffness matrix generated in each time step after the switching is reduced. Thus, the convergence of the nonlinear algorithm is improved, and the accuracy of the calculated physical quantity is improved.

In a case where the index ER is equal to or smaller than the threshold TH1, the control unit 415 determines that the error caused by the first generation method is not accumulated, and continues to apply the first generation method. In this case, the first analysis processing by the generation unit 412-1 and the calculation unit 413-1 is iterated until the time step reaches a time step of next error evaluation.

The index ER is calculated by using the element stiffness matrix M1 and the element stiffness matrix M2 of the evaluation target element, and thus, whether or not the error caused by the first generation method is accumulated may be evaluated with a small amount of computation.

In a case where the first generation method is changed to the second generation method, the generation unit 412-1 and the calculation unit 413-1 iterate the second analysis processing over time steps of X times. After the second analysis processing is iterated X times, the control unit 415 changes the second generation method to the first generation method again. In this case, the second analysis processing by the generation unit 412-2 and the calculation unit 413-2 is ended, and the first analysis processing by the generation unit 412-1 and the calculation unit 413-1 is restarted. X is an example of a predetermined number of times.

The method for generating the stiffness matrix is switched to the first generation method after the second analysis processing is iterated X times, and thus, the structure analysis simulation may be performed at a high speed by using the stiffness matrix with a reduced error in subsequent time steps. Accordingly, a speed of the structure analysis simulation may be increased while deterioration in calculation accuracy is suppressed.

X may be designated by the user or may be determined based on the index ER. In a case where X is determined based on the index ER, in the time step of the error evaluation, the control unit 415 calculates X by Equation below, for example.

X=int((|ER−TH2|/TH2)+1)*10 (2)

int () is a function for converting a value in parentheses into an integer, and represents a maximum integer that is equal to or smaller than the value in parentheses. A threshold TH2 may be designated by the user or may be calculated based on an experiment result. According to Equation (2), as an absolute value of a difference between ER and TH2 is larger, a value of X is also larger.

The number X of iterations of the second analysis processing is increased in a case where ER is large, so that the error of the stiffness matrix is corrected by the second generation method for a long period. Thus, the calculation accuracy in each time step after the first analysis processing is restarted is improved.

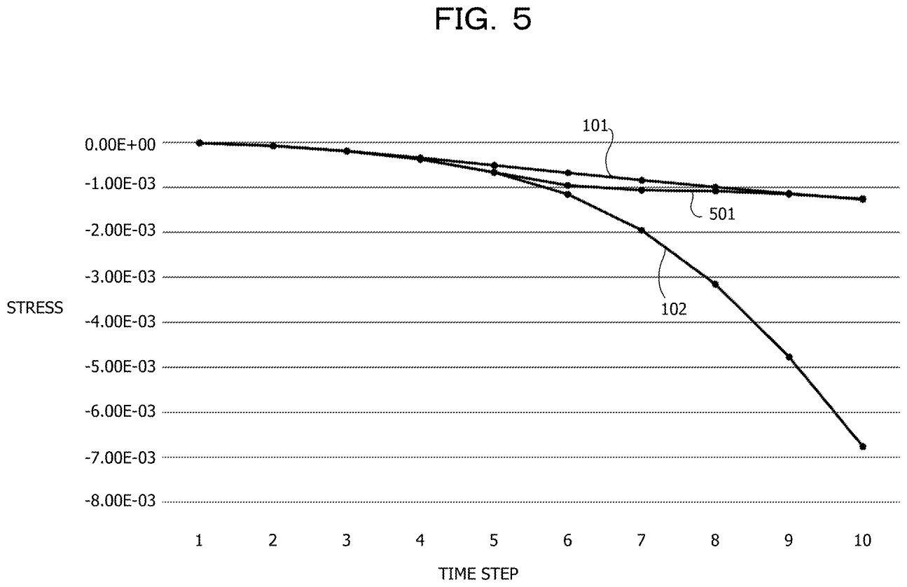

FIG. 5 illustrates an example of the temporal change in stress in the structure analysis simulation of the embodiment. The analysis target of the structure analysis simulation in FIG. 5 is the same Earth's crust as in FIG. 1, and a method for dividing the Earth's crust is also the same as in FIG. 1. In the simulation result in FIG. 5, a polygonal line 501 is added to the simulation result in FIG. 1.

The polygonal line 501 indicates the temporal change in stress calculated by the simulation apparatus 401 in FIG. 4. A method for generating the stiffness matrix by using the neural network is used as the first generation method, and the FEM is used as the second generation method. The stiffness matrix is generated by using the neural network in time step 1 to time step 5, and the stiffness matrix is generated by the FEM in time step 6 to time step 10.

In the case of the polygonal line 501, the error is dynamically corrected in time step 6 to time step 10 by switching the generation method of the stiffness matrix to the FEM in time step 6, and the calculated stress gradually approaches the polygonal line 101. Accordingly, a more accurate analysis result than in the case of the polygonal line 102 in which the generation method of the stiffness matrix is not switched is obtained.

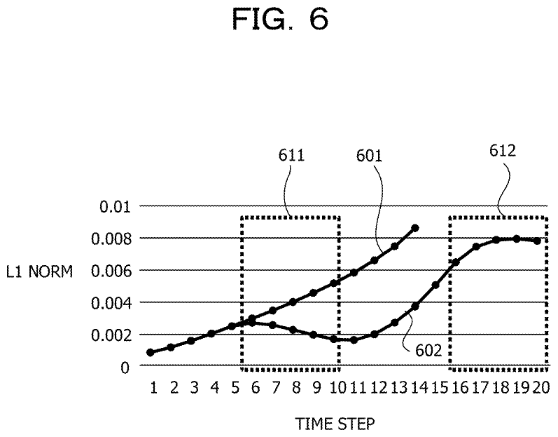

Next, an example of a temporal change in displacement error in the structure analysis simulation in FIG. 5 will be described with reference to FIGS. 6 to 9.

In the following description, simulation S0 represents the structure analysis simulation in which the stiffness matrix is generated by the FEM in all time steps. Simulation S1 represents a structure analysis simulation in which the stiffness matrix is generated by using the neural network in all time steps. Simulation S2 represents a structure analysis simulation in which the simulation apparatus 401 in FIG. 4 generates the stiffness matrix while switching between the neural network and the FEM.

A displacement error in the simulation S1 represents a difference between displacement calculated in the simulation S1 and displacement calculated in the simulation S0. This error is calculated by using displacement of each of the plurality of nodes calculated in the simulation S1 and displacement of each of the plurality of nodes calculated in the simulation S0.

A displacement error in the simulation S2 represents a difference between displacement calculated in the simulation S2 and displacement calculated in the simulation S0. This error is calculated by using displacement of each of the plurality of nodes calculated in the simulation S2 and displacement of each of the plurality of nodes calculated in the simulation S0.

In the examples in FIGS. 6 to 9, an L1 norm, an L2 norm, or a maximum value norm is used as the displacement error in the simulation S1 or the simulation S2.

FIG. 6 illustrates an example of a first temporal change in the L1 norm. A horizontal axis represents a time step and a vertical axis represents the L1 norm. A polygonal line 601 indicates a temporal change in the L1 norm in the simulation S1. A polygonal line 602 indicates a temporal change in the L1 norm in the simulation S2.

In the simulation S2, the generation method of the stiffness matrix is switched whenever five time steps elapse, and the stiffness matrix is generated by using the neural network in time step 1 to time step 5 and time step 11 to time step 15. By contrast, the stiffness matrix is generated by the FEM in time step 6 to time step 10 and time step 16 to time step 20. A period 611 and a period 612 represent periods in which the FEM is used as the generation method of the stiffness matrix.

The L1 norm indicated by the polygonal line 601 monotonically increases in time step 1 to time step 14, and diverges in time step 15 and subsequent time steps.

The L1 norm indicated by the polygonal line 602 increases in time step 1 to time step 5 in which the neural network is used, in the same manner as the polygonal line 601. Subsequently, in time step 6 to time step 10 in which the FEM is used, the L1 norm monotonically decreases, which suggests that the error is corrected by the FEM.

Subsequently, in time step 11 to time step 15 in which the neural network is used, the L1 norm monotonically increases again. Subsequently, in time step 16 to time step 20 in which the FEM is used, the L1 norm continuously increases, which suggests that a time for correcting the error is insufficient in five time steps.

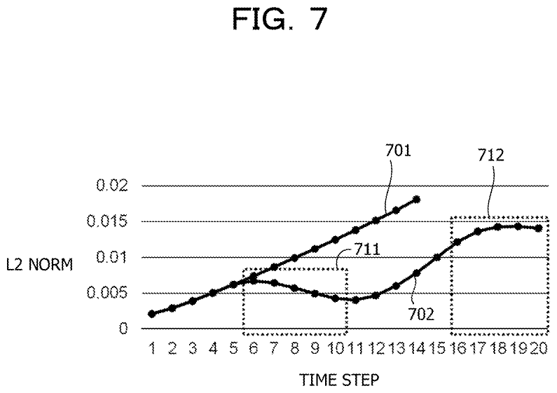

FIG. 7 illustrates an example of a temporal change in the L2 norm. A horizontal axis represents a time step and a vertical axis represents the L2 norm. A polygonal line 701 indicates a temporal change in the L2 norm in the simulation S1. A polygonal line 702 indicates a temporal change in the L2 norm in the simulation S2. A period 711 and a period 712 represent periods in which the FEM is used as the generation method of the stiffness matrix in the simulation S2.

In the same manner as the L1 norm indicated by the polygonal line 602 in FIG. 6, the L2 norm indicated by the polygonal line 702 monotonically decreases in time step 6 to time step 10 in which the FEM is used, which suggests that the error is corrected by the FEM. On the other hand, the L2 norm continuously increases in time step 16 to time step 20 in which the FEM is used, which suggests that the time for correcting the error is insufficient in five time steps.

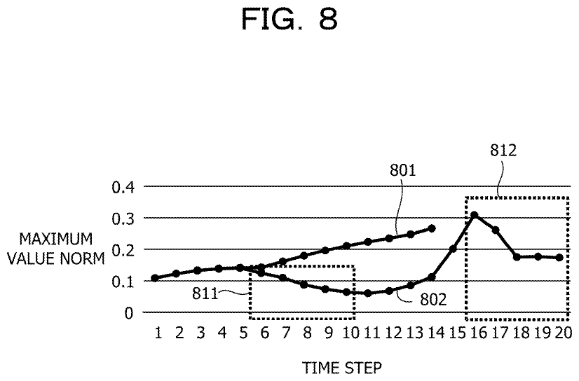

FIG. 8 illustrates an example of a temporal change in the maximum value norm. A horizontal axis represents a time step and a vertical axis represents the maximum value norm. A polygonal line 801 indicates a temporal change in the maximum value norm in the simulation S1. A polygonal line 802 indicates a temporal change in the maximum value norm in the simulation S2. A period 811 and a period 812 represent periods in which the FEM is used as the generation method of the stiffness matrix in the simulation S2.

The maximum value norm indicated by the polygonal line 801 monotonically increases in time step 1 to time step 14, and diverges in time step 15 and subsequent time steps.

The maximum value norm indicated by the polygonal line 802 increases in time step 1 to time step 5 in which the neural network is used in the same manner as the polygonal line 801. Subsequently, in time step 6 to time step 10 in which the FEM is used, the maximum value norm monotonically decreases, which suggests that the error is corrected by the FEM.

Subsequently, in time step 11 to time step 15 in which the neural network is used, the maximum value norm monotonically increases again. Subsequently, in time step 16 to time step 20; in which the FEM is used, the maximum value norm temporarily decreases and is then maintained at a fixed value.

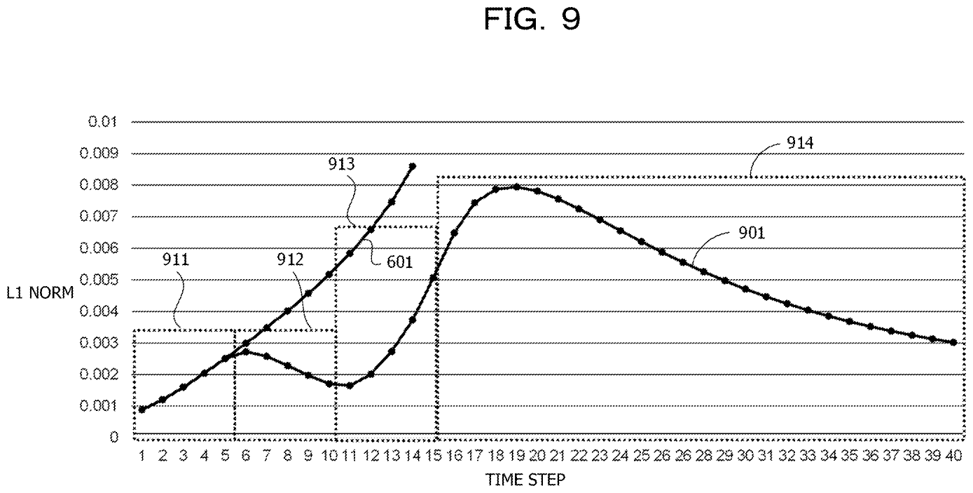

FIG. 9 illustrates an example of a second temporal change in the L1 norm. A horizontal axis represents a time step and a vertical axis represents the L1 norm. In the same manner as in FIG. 6, the polygonal line 601 indicates the temporal change in the L1 norm in the simulation S1. A polygonal line 901 indicates a temporal change in the L1 norm in the simulation S2.

In the example in FIG. 9, after the generation method of the stiffness matrix in the simulation S2 is changed to the FEM in time step 16, the FEM is continuously used over 25 time steps. A period 911 and a period 913 represent periods in which the neural network is used as the generation method of the stiffness matrix. A period 912 and a period 914 represent periods in which the FEM is used as the generation method of the stiffness matrix.

The L1 norm indicated by the polygonal line 901 changes in time step 1 to time step 15 in the same manner as the polygonal line 602 in FIG. 6. Subsequently, in time step 16; to time step 40 of the period 914 in which the FEM is used, the L1 norm temporarily increases and then monotonically decreases, which suggests that the error is corrected by the FEM. The period 914 including 25 time steps may be said to be a time sufficient for correcting the error.

Besides the structure analysis simulation of the object, the simulation apparatus 401 may also perform a simulation for another analysis target such as an electric field or a magnetic field.

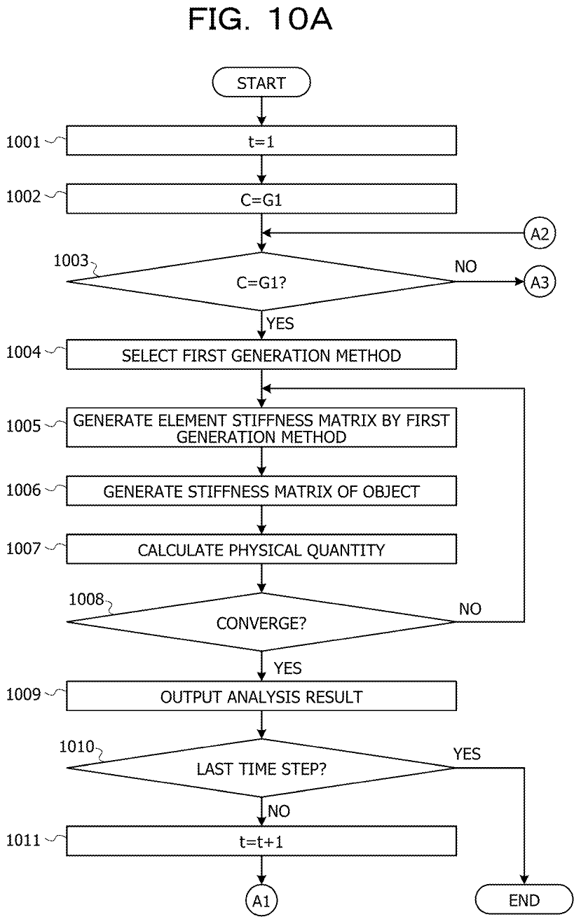

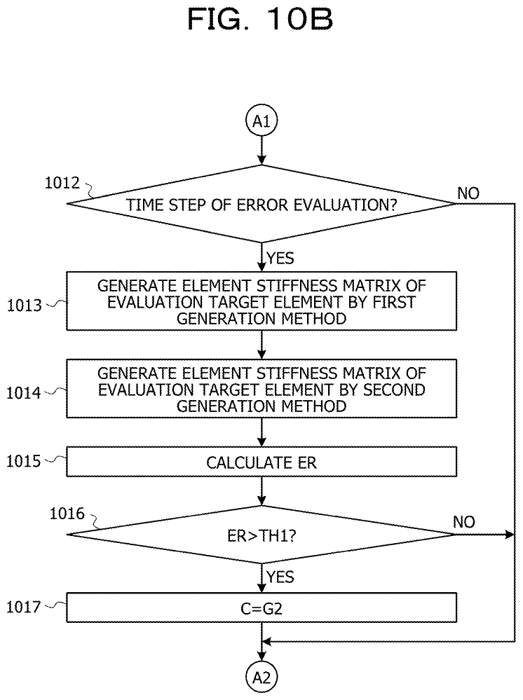

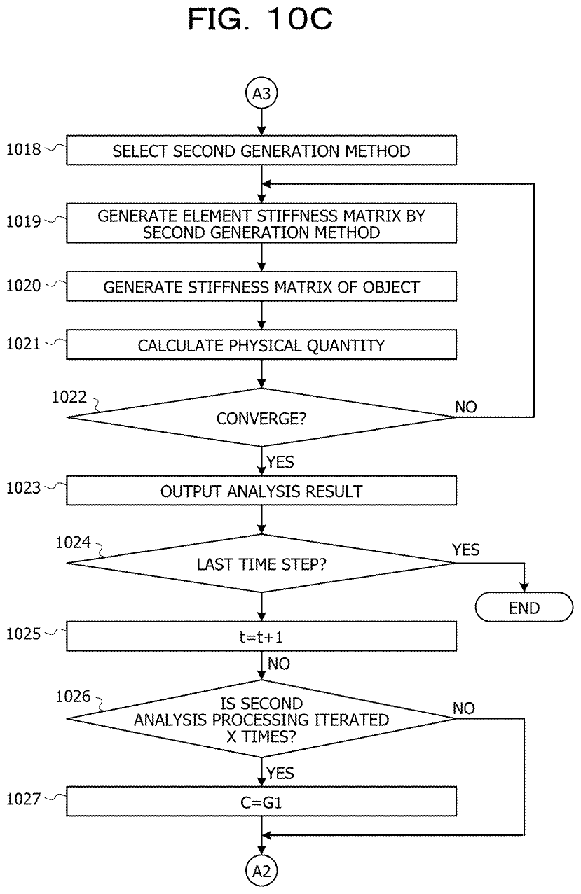

FIGS. 10A to 10C are flowcharts illustrating an example of the second simulation processing performed by the simulation apparatus 401 in FIG. 4.

First, the control unit 415 sets 1 indicating an initial time step in a control variable t indicating the time step (step 1001), and sets G1 indicating the first generation method in a control variable C indicating the generation method of the stiffness matrix (step 1002).

Subsequently, the control unit 415 checks a value of C (step 1003). In a case where C=G1 (YES in step 1003), the control unit 415 selects the first generation method as the generation method of the stiffness matrix (step 1004).

Subsequently, the generation unit 412-1 generates the element stiffness matrix of each element by the first generation method by using the element information 422 of the element (step 1005).

Subsequently, the calculation unit 413-1 generates the stiffness matrix of the entire object by using the element stiffness matrix of each element generated by the first generation method (step 1006). The calculation unit 413-1 calculates the physical quantity of each node of each element by using the stiffness matrix of the entire object (step 1007).

Subsequently, the calculation unit 413-1 checks whether or not approximate calculation for calculating the physical quantity has converged (step 1008). In a case where the approximate calculation has not converged (NO in step 1008), the simulation apparatus 401 iterates the processing in step 1005 and subsequent steps as a next approximate calculation step.

In a case where the approximate calculation has converged (YES in step 1008), the output unit 416 outputs the calculated physical quantity, as an analysis result in a current time step (step 1009). The processing in steps 1004 to 1009 correspond to the first analysis processing based on the first generation method.

Subsequently, the control unit 415 checks whether or not t indicates the last time step of the structure analysis simulation (step 1010). In a case where t does not indicate the last time step (NO in step 1010), the control unit 415 increments t by 1 (step 1011). The control unit 415 checks whether or not t indicates the time step of the error evaluation (step 1012).

In a case where t indicates the time step of the error evaluation (YES in step 1012), the generation unit 414-1 generates the element stiffness matrix M1 of each evaluation target element by the first generation method by using the element information 422 of the evaluation target element (step 1013).

Subsequently, the generation unit 414-2 generates the element stiffness matrix M2; of each evaluation target element by the second generation method by using the element information 422 of the evaluation target element (step 1014).

Subsequently, the control unit 415 calculates the index ER by using the element stiffness matrix M1 and the element stiffness matrix M2 of each evaluation target element (step 1015), and compares the index ER with the threshold TH1 (step 1016).

In a case where the index ER is larger than the threshold TH1 (YES in step 1016), the control unit 415 sets G2 indicating the second generation method to C (step 1017). The simulation apparatus 401 iterates the processing in step 1003 and subsequent steps.

In a case where t does not indicate the time step of the error evaluation (NO in step 1012) or in a case where the index ER is equal to or smaller than the threshold TH1 (NO in step 1016), the simulation apparatus 401 iterates the processing in step 1003 and subsequent steps.

In a case where t indicates the last time step (YES in step 1010), the simulation apparatus 401 ends the processing.

In a case where C=G2 (NO in step 1003), the control unit 415 selects the second generation method as the generation method of the stiffness matrix (step 1018).

Subsequently, the generation unit 412-2 generates the element stiffness matrix of each element by the second generation method by using the element information 422 of the element (step 1019).

Subsequently, the calculation unit 413-2 generates the stiffness matrix of the entire object by using the element stiffness matrix of each element generated by the second generation method (step 1020). The calculation unit 413-2 calculates the physical quantity of each node of each element by using the stiffness matrix of the entire object (step 1021).

Subsequently, the calculation unit 413-2 checks whether or not approximate calculation for calculating the physical quantity has converged (step 1022). In a case where the approximate calculation has not converged (NO in step 1022), the simulation apparatus 401 iterates the processing in step 1019 and subsequent steps, as a next approximate calculation step.

In a case where the approximate calculation has converged (YES in step 1022), the output unit 416 outputs the calculated physical quantity, as an analysis result in a current time step (step 1023). The processing in steps 1018 to 1023 correspond to the second analysis processing based on the second generation method.

Subsequently, the control unit 415 checks whether or not t indicates the last time step (step 1024). In a case where t does not indicate the last time step (NO in step 1024), the control unit 415 increments t by 1 (step 1025). The control unit 415 checks whether or not the second analysis processing based on the second generation method is iterated over time steps of X times (step 1026).

In a case where the second analysis processing is iterated X times (YES in step 1026), the control unit 415 sets G1 to C (step 1027). The simulation apparatus 401 iterates the processing in step 1003 and subsequent steps.

In a case where the second analysis processing is not iterated X times (NO in step 1026), the simulation apparatus 401 iterates the processing in step 1003 and subsequent steps.

In a case where t indicates the last time step (YES in step 1024), the simulation apparatus 401 ends the processing.

The configurations of the simulation apparatus 201 in FIG. 2 and the simulation apparatus 401 in FIG. 4 are merely an example, and a part of the components may be omitted or changed in accordance with an application or conditions of the simulation apparatus.

The flowcharts of FIGS. 3 and 10A to 10C are merely an example, and a part of the processing may be omitted or changed in accordance with the configuration or the conditions of the simulation apparatus.

The temporal changes in stress illustrated in FIGS. 1 and 5 are merely an example, and the temporal changes in stress changes in accordance with the analysis target. The temporal changes in the displacement error illustrated in FIGS. 6 to 9 are merely an example, and the temporal changes in the displacement error change in accordance with the analysis target.

Equations (1) and (2) are merely an example, and the simulation apparatus 401 may calculate the indices ER and X by using other calculation expressions.

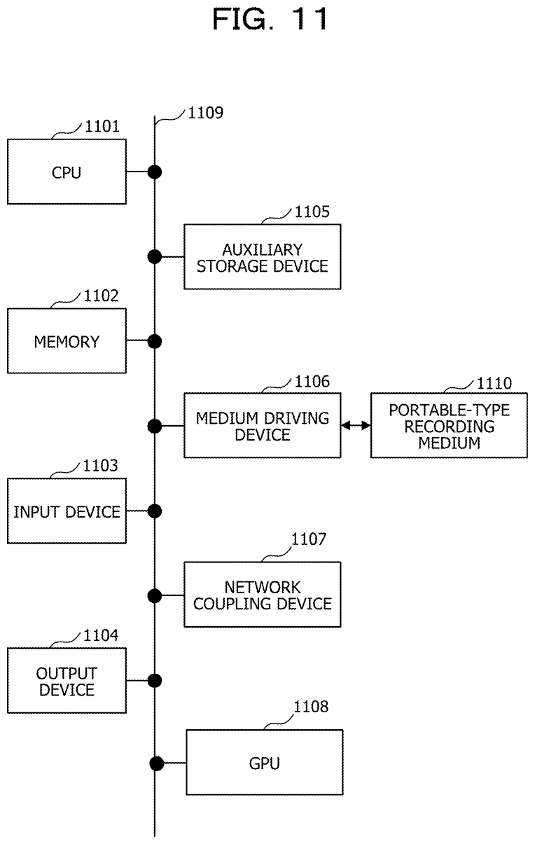

FIG. 11 illustrates a hardware configuration example of an information processing apparatus (computer) used as the simulation apparatus 201 in FIG. 2 and the simulation apparatus 401 in FIG. 4.

The information processing apparatus in FIG. 11 includes a central processing unit (CPU) 1101, a memory 1102, an input device 1103, and an output device 1104. The information processing apparatus further includes an auxiliary storage device 1105, a medium driving device 1106, a network coupling device 1107, and a graphics processing unit (GPU) 1108. These components are pieces of hardware, and are coupled to each other by a bus 1109.

The memory 1102 is, for example, a semiconductor memory such as a read-only memory (ROM) or a random-access memory (RAM), and stores a program and data used for processing. The memory 1102 may operate as the storage unit 417 in FIG. 4.

For example, by executing the program by using the memory 1102, the CPU 1101 (processor) operates as the second analysis unit 211-2 and the change unit 212 in FIG. 2. By executing the program by using the memory 1102, the CPU 1101 also performs the processing of calculating the physical quantity which is performed by the first analysis unit 211-1.

By executing the program by using the memory 1102, the CPU 1101 also operates as the division unit 411, the generation unit 412-2, the calculation unit 413-1, the calculation unit 413-2, the generation unit 414-2, and the control unit 415 in FIG. 4. By executing the program by using the memory 1102, the CPU 1101 may operate as the generation unit 412-1 and the generation unit 414-1.

For example, the input device 1103 is a keyboard, a pointing device, or the like, and is used to input information or an instruction from a user or operator. For example, the output device 1104 is a display device, a printer, or the like, and is used to output a processing result and an inquiry or instruction to a user or operator. The output device 1104 may operate as the output unit 416 in FIG. 4, and the processing result may be the analysis result.

For example, the auxiliary storage device 1105 is a magnetic disk device, an optical disk device, a magneto-optical disk device, a tape device, or the like. The auxiliary storage device 1105 may be a hard disk drive or a solid- state drive (SSD). The information processing apparatus may store a program and data in the auxiliary storage device 1105, and may use the program and data by loading the program and data into the memory 1102. The auxiliary storage device 1105 may operate as the storage unit 417 in FIG. 4.

The medium driving device 1106 drives a portable-type recording medium 1110, and accesses contents recorded therein. The portable-type recording medium 1110 is a memory device, a flexible disk, an optical disk, a magneto-optical disk, or the like. The portable-type recording medium 1110 may be a compact disk read-only memory (CD-ROM), a Digital Versatile Disk (DVD), a Universal Serial Bus (USB) memory, or the like. A user or operator may store a program and data in the portable-type recording medium 1110, and may use the program and data by loading the program and data into the memory 1102.

As described above, a computer-readable recording medium in which a program and data used for processing are stored is a physical (non-transitory) recording medium such as the memory 1102, the auxiliary storage device 1105, or the portable-type recording medium 1110.

The network coupling device 1107 is a communication interface circuit that is coupled to a communication network such as a wide area network (WAN) or a local area network (LAN) and performs data conversion associated with communication. The information processing apparatus may receive a program and data from an external apparatus via the network coupling device 1107, and may use the program and data by loading the program and data into the memory 1102. The network coupling device 1107 may operate as the output unit 416 in FIG. 4.

The GPU 1108 is an arithmetic processing circuit that performs information processing. The GPU 1108 may operate as the generation unit 412-1 and the generation unit 414-1 in FIG. 4.

The information processing apparatus may not include all the components in FIG. 11. A part of the components may be omitted or changed in accordance with the application or conditions of the information processing apparatus. For example, in a case where an interface with a user or operator may not be used, the input device 1103 and the output device 1104 may be omitted. In a case where the portable-type recording medium 1110 or a communication network is not used, the medium driving device 1106 or the network coupling device 1107 may be omitted.

Although the disclosed embodiment and its advantages have been described in detail, those skilled in the art would be able to make various changes, additions, and omissions without deviating from the scope of the present disclosure clearly described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a simulation program for causing a computer to execute a process comprising:
iterating first analysis processing based on a first generation method for generating a stiffness matrix of an analysis target;
calculating an index related to an error of the stiffness matrix generated by the first generation method after the first analysis processing is iterated;
changing the first generation method to a second generation method that has higher accuracy than the first generation method based on the index related to the error; and
iterating second analysis processing based on the second generation method, wherein
the first analysis processing includes
generating the stiffness matrix of the analysis target by the first generation method, and
calculating a physical quantity related to the analysis target by using the stiffness matrix generated by the first generation method, and
the second analysis processing includes generating the stiffness matrix of the analysis target by the second generation method, and
calculating the physical quantity related to the analysis target by using the stiffness matrix generated by the second generation method.

2. The non-transitory computer-readable recording medium according to claim 1, wherein
the calculating of the index related to the error includes
generating a first element stiffness matrix of an evaluation target element by the first generation method by using, as the evaluation target element, any element among a plurality of elements that represent the analysis target,
generating a second element stiffness matrix of the evaluation target element by the second generation method, and
calculating the index related to the error by using the first element stiffness matrix and the second element stiffness matrix.

3. The non-transitory computer-readable recording medium according to claim 1, wherein
the iterating of the second analysis processing includes iterating the second analysis processing by a predetermined number of times, and the process further comprises:
changing the second generation method to the first generation method after the second analysis processing is iterated the predetermined number of times; and
iterating the first analysis processing based on the first generation method.

4. The non-transitory computer-readable recording medium according to claim 3, wherein
the predetermined number of times is determined based on the index related to the error.

5. The non-transitory computer-readable recording medium according to claim 1, wherein
the first generation method is a generation method using a machine learning model, and the second generation method is a numerical calculation method based on a finite element method.

6. A simulation apparatus comprising:
a memory, and
a processor coupled to the memory and configured to:
iterate first analysis processing based on a first generation method for generating a stiffness matrix of an analysis target;
calculate an index related to an error of the stiffness matrix generated by the first generation method after the first analysis processing is iterated;
change the first generation method to a second generation method that has higher accuracy than the first generation method based on the index related to the error; and
iterate second analysis processing based on the second generation method, wherein
the first analysis processing includes generating the stiffness matrix of the analysis target by the first generation method, and
calculating a physical quantity related to the analysis target by using the stiffness matrix generated by the first generation method, and the second analysis processing includes
generating the stiffness matrix of the analysis target by the second generation method, and
calculating the physical quantity related to the analysis target by using the stiffness matrix generated by the second generation method.

7. The simulation apparatus according to claim 6, wherein
the calculate of the index related to the error includes
generating a first element stiffness matrix of an evaluation target element by the first generation method by using, as the evaluation target element, any element among a plurality of elements that represent the analysis target,
generating a second element stiffness matrix of the evaluation target element by the second generation method, and
calculating the index related to the error by using the first element stiffness matrix and the second element stiffness matrix.

8. The simulation apparatus according to claim 6, wherein
the iterate of the second analysis processing includes iterating the second analysis processing by a predetermined number of times, and
the processor is further configured to:
change the second generation method to the first generation method after the second analysis processing is iterated the predetermined number of times; and
iterating the first analysis processing based on the first generation method.

9. The simulation apparatus according to claim 8, wherein
the predetermined number of times is determined based on the index related to the error.

10. The simulation apparatus according to claim 6, wherein
the first generation method is a generation method using a machine learning model, and the second generation method is a numerical calculation method based on a finite element method.

11. A simulation method performed by a computer, the simulation method comprising:
iterating first analysis processing based on a first generation method for generating a stiffness matrix of an analysis target;
calculating an index related to an error of the stiffness matrix generated by the first generation method after the first analysis processing is iterated;
changing the first generation method to a second generation method that has higher accuracy than the first generation method based on the index related to the error; and
iterating second analysis processing based on the second generation method, wherein
the first analysis processing includes
generating the stiffness matrix of the analysis target by the first generation method, and
calculating a physical quantity related to the analysis target by using the stiffness matrix generated by the first generation method, and
the second analysis processing includes
generating the stiffness matrix of the analysis target by the second generation method, and
calculating the physical quantity related to the analysis target by using the stiffness matrix generated by the second generation method.

12. The simulation method according to claim 11, wherein
the calculating of the index related to the error includes generating a first element stiffness matrix of an evaluation target element by the first generation method by using, as the evaluation target element, any element among a plurality of elements that represent the analysis target,
generating a second element stiffness matrix of the evaluation target element by the second generation method, and
calculating the index related to the error by using the first element stiffness matrix and the second element stiffness matrix.

13. The simulation method according to claim 11, wherein
the iterating of the second analysis processing includes iterating the second analysis processing by a predetermined number of times, and
the process further comprises:
changing the second generation method to the first generation method after the second analysis processing is iterated the predetermined number of times; and
iterating the first analysis processing based on the first generation method.

14. The simulation method according to claim 13, wherein the predetermined number of times is determined based on the index related to the error.

15. The simulation method according to claim 11, wherein
the first generation method is a generation method using a machine learning model, and the second generation method is a numerical calculation method based on a finite element method.
